(19) United States
(12) Patent Application Publication
(10) Pub. No.: US 2016/0300180 A1
(43) Pub. Date: Oct. 13, 2016

(54) PRODUCT DATA ANALYSIS

(71) Applicant: HEWLETT PACKARD ENTERPRISE DEVELOPMENT LP, Houston, TX (US)

(72) Inventors: Cara J. Curtland, Vancouver, WA (US); Brad David Wolf, Roseville, CA (US); Jerry Hwang, Cupertino, CA (US); Dave Chang, Vancouver, WA (US); Divya Mangotra, Vancouver, WA (US)

(73) Assignee: Hewlett Packard Enterprise Development LP, Houston, TX (US)

(21) Appl. No.: 15/035,810

(22) PCT Filed: Nov. 15, 2013
(86) PCT No.: PCT/US2013/070447

§ 371 Date: May 11, 2016

(51) Int. Cl. G06Q 10/08; G06F 3/0484; G06Q 10/04

(52) U.S. Cl. CPC G06Q 10/087; G06Q 10/04; G06F 3/04842; G06F 3/04847

(57) ABSTRACT

An example method for analyzing product data in accordance with aspects of the present disclosure includes obtaining data associated with a product, the data comprising a plurality of parameters, updating the data based on elimination of at least one data point in the data, validating the updated data, providing visual analysis of the updated data, and determining a recommendation based on the updated data, wherein the recommendation is related to at least one of the plurality of parameters.

### BACKGROUND

Inventory optimization is important for retail businesses involved with the sale of finished goods and products as well as for manufacturing businesses that produce finished goods, products and/or components for use in other goods and products. The management of the inventory may be based on several variables and targets, including budgetary targets, product priorities, and inventory costs.

### BRIEF DESCRIPTION OF THE DRAWINGS

Example implementations are described in the following detailed description and in reference to the drawings, in which:

FIG. 1 illustrates an example system diagram in accordance with various examples;

FIG. 2 illustrates an example of a forecast value analysis system in accordance with various examples;

FIG. 3 illustrates a component of a user interface in accordance with various examples;

FIG. 4 illustrates a component of a user interface in accordance with various examples; and

FIG. 5 illustrates an example method in accordance with various examples.

### DETAILED DESCRIPTION

Various implementations described herein are directed to inventory optimization. More specifically, and as described in greater detail below, various aspects of the present disclosure are directed to a manner by which a set of processes are implemented using a platform to allow a business to optimize end to end inventory, control cash flow, and minimize cyclical behavior in working capital throughout the quarter.

Aspects of the present disclosure described herein implement a comprehensive and integrated tool that allows inventory management and intelligent decision making. Inventory optimization requires balancing capital investment constraints or objectives and service-level goals over a large assortment of stock-keeping units (SKUs) while taking demand and supply volatility into account. Organizations can manage data on millions of SKUs, gather and consolidate huge data volumes throughout the distribution chain, then transform, standardize and cleanse the data for inventory optimization. Also, in order to maximize the outcome of product-related decisions, retail store and supplier management may use statistical modeling and strategic planning to optimize the decision making process for many product decisions. Among other things, this approach allows the user to utilize such tools to achieve these goals.

According to various aspects of the present disclosure, the approach described herein allows a user to view information without having to switch between multiple screens. Accordingly, this approach may prevent the user from having to look at variety of screens, which can lead to inefficiency and errors in decision making due to possibly missing critical information while switching between different resources. Such aspects, among other things, increase the simplicity of the operation the electronic device and lead to an enjoyable experience.

Moreover, aspects of the present disclosure described herein also allow the user to compare historical forecasts and consumption to identify a better predictor for future shipments. Among other things, this approach allows the user to control cash flow and lower working capital requirements.

In one example in accordance with the present disclosure, a method for analyzing product data is provided. The method comprises obtaining data associated with a product, the data comprising a plurality of parameters, updating the data based on elimination of at least one data point in the data, validating the updated data, providing visual analysis of the updated data, and determining a recommendation based on the updated data, wherein the recommendation is related to at least one of the plurality of parameters.

In another example in accordance with the present disclosure, a system is provided. The system comprises a data capturing module to obtain data associated with a product, the data comprising a plurality of parameters, a calculation module to update the data by removing at least one data point from the data, and calculate the plurality of parameters using the updated data, a replacement module to validate the updated data based on sufficiency of the data related to the product, a display module to provide visual analysis of the updated data, the display module controlling a plurality of display regions representing at least one of the plurality of parameters, and a recommendation module to provide a recommendation related to at least one of the plurality of parameters.

In a further example in accordance with the present disclosure, a non-transitory computer-readable medium is provided. The non-transitory computer-readable medium comprises instructions that when executed cause a device to (i) obtain data associated with a product, the data comprising a plurality of parameters, (ii) update the plurality of parameters based on an elimination of at least one data point in the data, and (iii) validate the plurality of parameters.

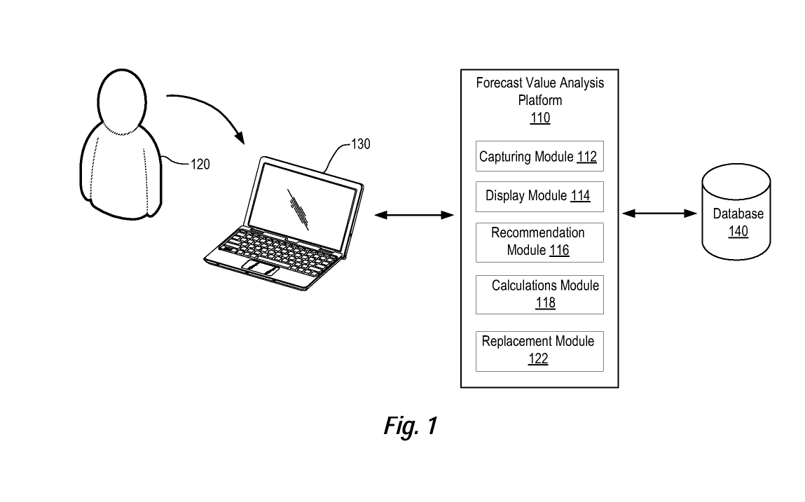

FIG. 1 illustrates an example forecast value analysis platform 110 in accordance with an implementation. The forecast value analysis platform 110 is a part of an inventory optimization system, and the platform 110 comprises a data capturing module 112, display module 114, recommendation module 116, calculation module 118 and replacement module 122, each of which is described in greater detail below. It should be readily apparent that the platform 110 illustrated in FIG. 1 represents a generalized depiction and that other components may be added or existing components may be removed, modified, or rearranged without departing from a scope of the present disclosure. Moreover, although the various modules 112-122 are shown as separate modules in FIG. 1, in other implementations, the functionality of all or a subset of the modules 112-122 may be implemented as a single module.

The forecast value analysis platform 110 may use supply chain management concepts to efficiently display the product forecasting information and contribute to the inventory optimization system's management of the product inventory levels to satisfy a number of factors. These factors may include, but are not limited to revenue goals, profit goals, market share goals and inventory budget constraints.

The platform 110 illustrates a tool for a user of the system (e.g., an inventory manager) to assess the performance of various products (e.g., parts) and take action. In one implementation, the part may comprise a product being sold or managed by the planner. Further, part information may include various attributes and data concerning a plurality of products. The data associated with each product may include a point of re-order value, an assigned category by the planner, and a plan of record. The various attributes and data in various combinations may be used by the platform 110 in presenting inventory. Additional data about the products may include historical forecasted demand and actual demand (also called consumption), delivery times for each product and an associated variability in the delivery times, and other basic product information (number, line, location, platform, etc.).

The platform 110 may perform tasks involving, but not limited to, data validation (outlier analysis), consumption and forecast error coefficient of variation (COV) calculation, forecast bias analysis, predecessor/successor mapping, product categorization and mapping (e.g., COV like-modeling), re-order point (ROP) type recommendation (e.g., consumption or forecast-based ROP).

The COV calculations may be based on actual historical usage data and/or forecasted data (e.g., sales growth forecasts). Accordingly, the platform 110 may consider a plurality of COV types and recommends one of the plurality of COV types to the user in order to optimize inventory investment. The forecast COV may be determined by analyzing forecast data points (e.g., component usage data indicative of forecasted consumption) for the particular component to establish a base inventory amount. For example, after determining the appropriate supplier lead-time for the particular component (e.g., 4 weeks), an average component forecast (e.g., sales forecast) may be calculated in the same units as the determined supplier lead-time (e.g., weekly average). Thereafter, the base inventory amount may be determined by multiplying the average component forecast by the supplier lead-time. The statistical inventory amount may be ascertained using COV, desired service level, and lead-time. The base inventory amount and the statistical inventory amount may then be added together to obtain the Forecast COV or target inventory level.

Further, the platform 110 may optimize inventory investment using historical usage and/or consumption of an inventory component by determining one or more target inventory levels (e.g., replenishment levels). In this regard, the system and techniques disclosed herein analyze historical production and/or consumption data and/or forecast data for a component and conduct one or more mathematical analyses to display fluctuations in usage over time within a supplier lead-time for the component. Resulting analyses generate various graphical views and tables related to forecast values.

In one implementation, the forecast value analysis platform 110 retrieves data from an operations database 140. The input for the forecast value analysis platform 110 comprises historical forecast and consumption history. The consumption and historical forecast data may be reviewed and/or updated and/or validated for anomalies. In some implementations, the platform 110 may be used to identify new product information that may have insufficient consumption and historical forecast data and accordingly, the platform 110 may assign predecessor relationships to such new product information. In addition, the platform 110 may evaluate and revise the COVs. The output from the forecast value analysis platform 110 may comprise forecast error COV (FE COV). More specifically, for example, FE COV may be a measure of the demand variability relative to forecast that has historically been seen on a given product or similar/representative product/product group. FE COV may be used to determine how much demand variability should be expected in the future to set an inventory buffering strategy to maintain a predictable level of availability of product. FE COV may comprise standard deviation of historical forecast error divided by the average forecast. Moreover, the output from the forecast value analysis platform 110 may comprise consumption-based COV, Bias, FVA, and suggested ROP type. The revised COV values may be loaded onto the operational database 140.

In one implementation the forecast value analysis platform 110 may comprise a plurality of global variables. The user may interact with the forecast value analysis platform 110 to adjust the global variables. The global variables may comprise a number of data points for average bias, which may set the number of most recent data points to use for a bias calculation (e.g. 8). Moreover, a number of data points for COV calculations may set the number of most recent data points to use for COV calculation (e.g., 8). Further, a number of data points for average FVA may set the number of most recent data points to use for average FVA calculation (e.g., 8).

Another global variable may include an outlier threshold. In one implementation, a forecast error threshold limit may be used in outlier analysis. For example, if the forecast error difference from prior week is greater than the outlier threshold (e.g., x %), the platform 110 may consider the forecast error difference outlier. The outlier data may be noted in an analysis tab of the platform 110. In one example, such data may be noted as Col Y: 0=no outlier and 1=outlier.

In another implementation, outliers may be determined by calculating a threshold for forecast error values and those values exceeding the threshold may be noted as 1=outlier. In this implementation, the threshold may be determined by calculating the mean and standard deviation of the forecast errors for the part-location and the threshold may be set to equal + or −3 standard deviations from the mean. For this implementation, a global variable may not be needed for outlier analysis.

A further global variable may include a number of data points for new outliers, which represent a number of weeks to look back to count the number of outliers. For example, the platform 110 may take last week, accordingly may scroll up five weeks and set threshold to review at the last five weeks. More specifically, in the event that the platform 110 performs a monthly process, last 5 weeks may be considered. In the event that the platform 110 performs a quarterly process, last 13 weeks may be considered, and in the event that the platform 110 performs a semi-annual process, last 26 weeks may be considered.

In FIG. 1, the platform 110 is shown as a stand-alone system and connected to a computing device 130, which is used by the user 120. In some implementations, the platform 110 may be incorporated into the computing device 130.

In one implementation, the computing device 130 may be in the form of any portable, mobile, or hand-held electronic device, such as a laptop, a notebook, a tablet device, a personal digital assistant (PDA), or a mobile phone. The computing device 130 may include a processor (e.g., central processing unit) and a computer memory (e.g., RAM). The computer memory may store data and instructions and the processor executes instructions and processes data from the computer memory. The processor may retrieve instructions and other data from storage device (e.g., hard drive) before loading such instructions and other data into the computer memory. The processor, computer memory and storage device may be connected by a bus in a conventional manner.

In one implementation, consistent with the present disclosure, a display may be a part of the electronic device 130. In another implementation, the display may be a stand-alone unit, separate from the electronic device 130. The electronic device 130 and/or the platform 110 (more specifically, the display module 114) may be coupled to the external display, for outputting a display signal to the display. In such implementation, the display may be connected to the electronic device 130 and/or the platform 110 through any type of interface or connection, including I2C, SPI, PS/2, Universal Serial Bus (USB), Bluetooth, RF, IRDA, keyboard scan lines or any other type of wired or wireless connection to list several non-limiting examples.

The display may refer to the graphical, textual and auditory information the platform 110 may present to the user 120, and the control sequences (e.g., keystrokes with the keyboard) the user 120 may employ to control the platform 110. In some implementations, the user 120 may interact with the electronic device 130 by a plurality of input devices, such as a keyboard, mouse, touch device, or verbal command. For example, the user 120 may control a keyboard, which may be an input device for the platform 110. The electronic device 130 may help translate input received by the keyboard. The user may perform various gestures on the keyboard. Such gestures may involve, but not limited to, touching, pressing, waiving, placing an object in proximity.

In one implementation, the platform 110 may comprise the capturing module 112. The capturing module 112 collects data from various components of inventory optimization system, which the platform 110 is a part of. The data may be used to derive further analysis by applying a set of algorithms.

The display module 114 comprises the data being displayed at a graphical view or widget. Multiple widgets may be displayed on a dashboard screen of the user, for use in managing inventory. The display module 114 display forecast value analysis to the user and allows the user to interact with the platform 110 to make selections or changes.

The recommendation module 116 may derive further analysis by applying a set of algorithms, and based on certain data, may recommend, for example, an ROP type (e.g., forecast or consumption based ROP). In one implementation, the user may choose to change certain data via the platform 110 based on the recommendation received from the recommendation module 116. In such implementation, the platform 110 may comprise an additional module (e.g., revision module), which saves changed data resulting from the recommendation provided by the recommendation module 116. For example, the recommendation engine may recommend an ROP type to the user based on the FVA value calculated by the inventory optimization system. For example, if the FVA value is equal to or greater than 0, the recommendation engine recommends forecast as the ROP type, and if the FVA value is less than 0, the recommendation engine recommends consumption as the ROP type.

The calculation module 118 may update the data associated with the variables utilized in the platform 110. In one implementation, the calculation module 118 may identify at least one data point to exclude from the calculation of the variables, including, but not limited to, RLT, RLT Fcst, RLT Cons Fcst, and RLT Actuals. In one example, the user may select the data points that may be eliminated. For example, the user may enter a Y (e.g., yes) in the SKIP? column, and in response to the entry by the user, the platform 110 may eliminate the data points associated with the SKIP? row containing the Y. The user may choose to eliminate a data point for a plurality of reasons. For example, the user may conclude that the data point is an outlier. Moreover, the user may be aware of a condition that leads to an inaccurate data point. Once at least one data point is identified, the calculation module 118 may perform the calculation of various parameters and update the data displayed in the tables in the platform.

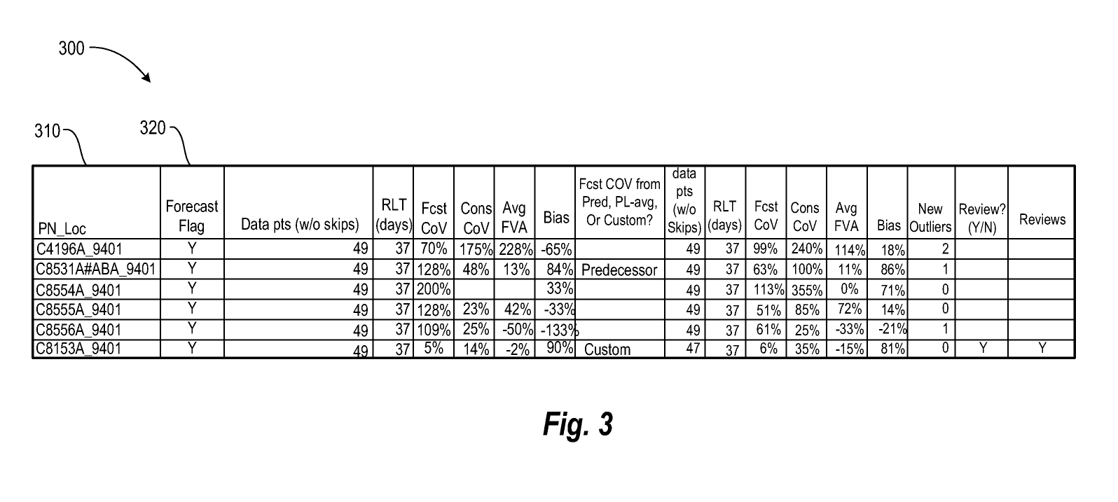

The replacement module 122 may determine that data associated with a part is not sufficient, and accordingly, request that the user selects an override process. The types of overrides that may be available to the user may comprise predecessor, product line average (PL-avg), and custom. Based on the selected method, the replacement module 122 proceeds to populate data related to various parameters. Each method will be described in greater detail in reference to FIG. 3.

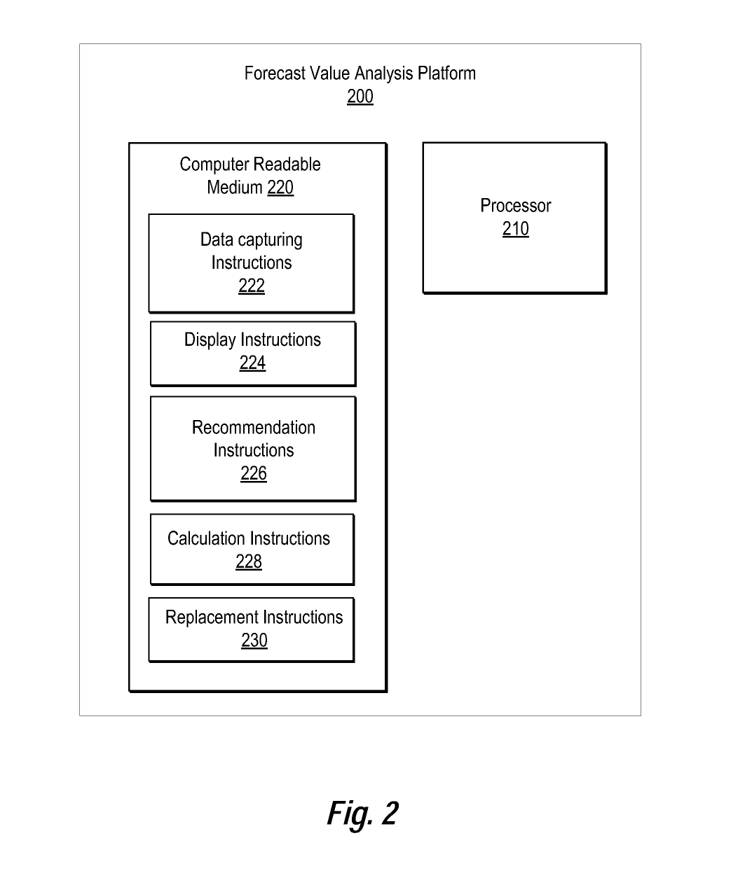

FIG. 2 illustrates example block diagram of the architecture of the forecast value analysis system 200 in accordance with an implementation. It should be readily apparent that the system 200 illustrated in FIG. 2 represents a generalized depiction and that other components may be added or existing components may be removed, modified, or rearranged without departing from a scope of the present disclosure. The system 200 comprises a processor 210 and a computer readable medium 220. The computer readable medium 220 comprises data capturing instructions 222, display instructions 224, and recommendation instructions 226.

In one implementation, the processor 210 may be in data communication with the computer readable medium 220. The processor 210 may retrieve and execute instructions stored in the computer readable medium 220. The processor 210 may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor 210 may fetch, decode, and execute instructions stored on the storage medium 220 to operate the device in accordance with the above-described examples. As an alternative or in addition to retrieving and executing instructions, the processor 210 may include at least one integrated circuit (IC), other control logic, other electronic circuits, or combinations thereof that include a number of electronic components for performing the functionality of instructions stored on the storage medium 220. Accordingly, the processor 210 may be implemented across multiple processing units and instructions stored on the storage medium 220 may be implemented by different processing units in different areas of the user device 300.

The computer readable medium 220 may be a non-transitory computer-readable medium that stores machine readable instructions, codes, data, and/or other information. In certain implementations, the computer readable medium 220 may be integrated with the processor 210, while in other implementations, the computer readable medium 220 and the processor 210 may be discrete units.

In one implementation, the computer readable medium 220 may include program memory that includes programs and software such as an operating system, user detection software component, and any other application software programs. Further, the computer readable medium 220 may participate in providing instructions to the processor 210 for execution. The computer readable medium 220 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

The instructions 222, 224, 226, stored on the storage medium 220, when executed by processor 210 (e.g., via one processing element or multiple processing elements of the processor) can cause processor 210 to perform processes, for example, the processes depicted herein.

Data capturing instructions 222 may cause the processor 210 to retrieve data associated with a product, which is identified by the user. Display instructions 224 may cause the processor 210 to provide visual analysis of the data. More specifically, the display instructions 224 may comprise instructions to control a plurality of display regions. A first of the plurality of display regions may include at least one graphical representation. Moreover, a second of the plurality of display regions includes a plurality of tables (e.g., cells). Accordingly, the first and second of the plurality of display regions represent provide visual information, such as, but not limited to, related to the forecast values of the product.

Recommendation instructions 226 may cause the processor 210 to present at least one recommendation to the user. The recommendation may be related to a parameter associated with the data. For example, the system may recommend that the user selects a specific type of a re-order point (ROP) (e.g., forecast or consumption based ROP). The system may review forecast value add (FVA) value of the product and determine what type of ROP is the best fit for the product. In one example, the system may determine that the FVA is 0 or greater, and the system may recommend using forecast based ROP. In another example, the system may determine that the FVA is less than 0, but that the consumption based ROP does not cover the forecast value. Accordingly, the system may recommend using forecast based ROP. In a further example, the system may determine that the FVA is less than 0, and the consumption based ROP covers the forecast value. Thus, the system may recommend using consumption based ROP. In various implementations, the user follows the recommendation presented by the system unless there is a valid reason (e.g., valid business driver) for not following the recommendation.

Calculation instructions 228 may cause the processor 210 to receive any data points from the user marked to be excluded from the calculations. Based on the eliminated data points, the processor proceeds to calculate various parameters identified in the forecast value analysis system. Further, the processor may store the results of the calculations in a database. In one implementation, the results of the calculations for the parameters may replace the existing values of the parameters in the database. In another implementation, the results of the calculations may be saved along with the existing values of the parameters as a new iteration.

Replacement instructions 230 may cause the processor 210 to receive a selection of an override method from the user and proceed with implementing the selected method. The selected method may comprise populating data fields associated with various parameters of the forecast value analysis system.

In one implementation, the computer readable medium 220 may have a plurality of databases, including, but not limited to, a planner profile database. The planner profile database may store planner profile data such as planner identification data, planner interface data, and profile management data and/or the like.

FIG. 3 illustrates an example summary component of a user interface for the forecast value analysis platform 110 of FIG. 1 in accordance with an implementation. The forecast value analysis platform comprises three components: global variables (as discussed above in reference to FIG. 1), summary and analysis. As shown in FIG. 3, the summary component may include a table 300. In particular, the summary component 300 may include various textual and numerical information and/or data related to one or more components or end items that may be populated from an operational database or a component of the forecast value analysis platform. It should be readily apparent that the part summary component 300 represents a generalized depiction and that other components may be added or existing table may be modified, or rearranged without departing from a scope of the present disclosure. For example, the summary component 300 comprises of a plurality of columns representing various variables. While the summary component 300 includes the shown columns, the forecast value analysis platform may actually comprise less or more variables, and the summary component 300 may be modified to show other variables.

A user interacting with the forecast value analysis platform may choose a product or a part. In one implementation, the user may provide an inventory manager ID to the platform 300 to filter the part/locations to only those assigned to the inventory manager. More specifically, the list of parts may be generated based on the user ID. For example, when the user enters the ID, the parts associated with that ID may be provided to the user. The user may choose to select all the products from the list, or the user may identify a subset of products from the list to focus on. The list 310 illustrated in FIG. 3 provides a list of products selected for this implementation.

In one implementation, the forecast value analysis platform may require that authentication information for a user to be able to view and control the platform. More specifically, an authorized individual may be required to enter information, such as a user ID/password of the authorized individual.

The table 300 displays a column for forecast flag 320. In one implementation, the forecast flag 320 may be marked Y for a part, and the user may choose to view all the products with a Y in the forecast flag column 320. In such event, the Y represents a current forecast for that part-location combination. In another implementation, the forecast flag 320 may be marked as N. In such implementation, all products (with and without forecast flags) may be displayed. Such setting allows the user to perform additional processes in the forecast value analysis platform. For example, the user may proceed with a predecessor modeling.

In one implementation, variables used in the forecast value analysis platform illustrated with the table 300 comprise replenishment lead time (RLT), forecast coefficient of variation (CoV) (i.e., forecast error CoV), consumption CoV (i.e., consumption forecast error oV), average forecast value add (FVA), related to at least one part (e.g., product, part of a product). In one implementation, the inputs for some of the variables may be retrieved from an operational database. The inputs to the table 300 may be contained in a single database or may be compiled from several databases distributed across an organization and connected via a network, such as a wide area network (WAN), a storage area network (SAN), or in various data servers connected to the internet. In some implementations, the inputs for other variables may be provided by other components of the forecast value analysis platform (e.g., calculations module).

RLT is measured in days and includes entire order-to-delivery period. The RLT may include its own confidence, such as 90%. The confidence, however, may change with supplier and or product based on experience. In another implementation, the RLT may be substituted with effective replenishment lead time (ERLT), which may include some additional lead time. More specifically, ERLT includes an entire order-to-delivery period and additional effective lead time due to limited supplier response capability outside of the replenishment lead time. The additional lead time may be calculated based on the product's CoV and any known supplier response parameters or factory operating guidelines.

Further, the table 300 comprises data related to forecast (FCST) based information and consumption (CONS) based information. For example, the CoV over the RLT period may have two values, one based on forecast and the other one based on historical consumption. In some implementations, the user may also analyze impacts of the change in the COV.

In some implementations, data associated with the part may not be sufficient, and the platform may allow the user to override any of the currently displayed data. In various implementations, the types of overrides that may be available to the user may comprise predecessor, product line average (PL-avg) and custom. In other implementations, the override may be the average of any of a plurality of attributes related to a product. The attributes may comprise, such as, but not limited to, location, component type and/or other classification of a product.

In one implementation, the user may choose predecessor as the override method. The user may type or copy/paste the predecessor p/n location combination. In response, the forecast value analysis platform may populate the corresponding data fields in other columns. For example, the forecast value analysis platform may pull the corresponding data from the adjusted calculation section of the analysis component of the forecast value analysis platform. In the event that the chosen predecessor does not have sufficient data, an error message may pop up and request that the user pick another predecessor.

In one implementation, the user may choose PL-avg as the override method. In response, the forecast value analysis platform may automatically calculate the product line average. In another implementation, the user may choose custom as the override method. For example, the user may enter the forecast COV and/or the consumption COV the user wishes to use. The user may determine the forecast and/or consumption COV to be used based on separate analysis. Further, once the override process is completed, the data may be reviewed and saved in the operational database.

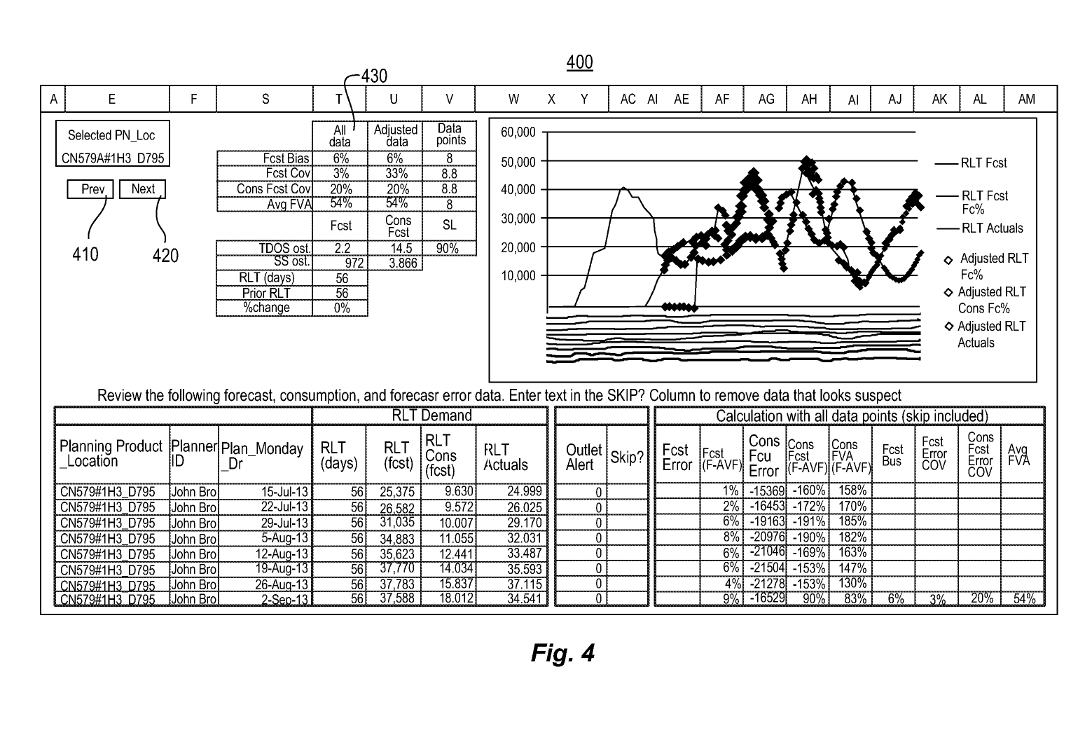

FIG. 4 illustrates an analysis component 400 of the user interface of the forecast value analysis platform in accordance with an implementation. It should be readily apparent that the summary component 400 illustrated in FIG. 4 represents a generalized depiction and that other components may be added or existing components may be removed, modified, or rearranged without departing from a scope of the present disclosure. For example, the summary component 400 comprises of one graph. While the summary component 400 illustrated in FIG. 4 includes one graph, the system may actually comprise less or more graphs, and only one has been shown and described for simplicity.

The analysis component 400 may include any appropriate number of portions or regions (e.g., display regions) each of which may be operable to convey various types of information to a user and/or allow the user to interact with the analysis component 400. For instance, the analysis component 400 may include a plurality of tables and plots. In particular, the analysis component 400 may include various textual and numerical information and/or data related to one or more components or end items that may be appropriately manipulated by a user. Further, the analysis component 400 may include one or more graphical representations (e.g., line graphs) related to one or more selected components or end items corresponding at least in part to the information located in the other parts (e.g., tables) of the analysis component 400. In one implementation, some of the data displayed in the tables in FIG. 4 may be retrieved from the operational database. Further, some of the data may be retrieved from other components (e.g., adjusted calculations section of the analysis component) of the platform.

In one implementation, the user may choose a plurality of parts in the summary component 300 of the platform. Accordingly, visual data related to the plurality of parts may be viewed in the analysis component 400 of the platform one part at a time. The user may use the prev button 410 and the next button 420 to navigate between the plurality of parts. The user may also choose a specific part from the list of the plurality of parts chosen by using the drop down selection list functionality of the tool.

The analysis component 400 comprises a plurality of tables with various variables including RLT, RLT Fcst, RLT Cons Fcst, RLT Actuals. These values for these variables are retrieved from the operational database. The RLT Fcst is a historical forecast over lead time counted from the date under column Plan_Monday_Dt. For example, the RLT Fcst in line 1 is 31,036. Accordingly, such information means forecast published on 29-Jul-13 was 31,036 units over 56 days (RLT value) counting from 29-Jul-13. RLT Cons Fcst value shows a bucketized average consumption over RLT (56 days) over a historical period of time counting from 29-Jul-13. In one implementation, the historical period of time used for consumption over RLT calculations may be 3 months. RLT Actuals represents actual consumptions over RLT (56 days) counting from 29-Jul-13.

Moreover, the analysis component 400 comprises other variables including Fcst error, Fcst (F-A)/F, Cons Fcst Error, Cons Fcst (F-A)/F, FVA, Fcst Bias, Fcst COV, Cons Fcst COV and Avg FVA.

Fcst error is the difference between RLT Fcst and RLT Actuals. Fcst (F-A)/F, which is expressed in % is calculated based on the following equation: (RLT Fcst-RLT Actuals)/RLT Fcst. Cons Fcst Error is the difference between RLT Cons Fcst and RLT Actuals. Cons Fcst (F-A)/F, which is expressed in % is calculated based on the following equation: (RLT Cons Fcst-RLT Actuals)/RLT Cons Fcst.

FVA may be calculated as the difference between absolute Cons Fcst (F-A)/F and absolute Fcst (F-A)/F. This value can be calculated for each historical date and can be used to compare the performance of the forecast versus the consumption over time.

Fcst Bias is Avg fcst error over bias weeks/Avg fcst over bias weeks, where bias weeks is a variable set as a part of the global variables as discussed above in reference to FIG. 1, which is time horizon for the bias calculation counting backwards from the most recent week. In one example, the number of bias week may be 8, and calculation may be done over 8 data points from the week of 2-Sep-13. The average of 8-week fcst error is 1884.875 (e.g., calculating the average of the values under Fcst error), and the average of 8-week RLT fcst is 29255.625 (e.g., calculating the average of the values under RLT Fcst), and thus the Fcst bias=1884.875/29255.625=6%.

Fcst COV is the standard deviation of the Fcst Error over COV weeks/Average Fcst over COV weeks, where COV weeks is a variable set as a part of the global variables as discussed above in reference to FIG. 1. In this case, the number of COV weeks is 8, the standard deviation of 8-week fcst error is 277.669, average 8-week RLT fcst is 29255.625, and thus Fcst COV=6.9/29255.625=3%.

Cons Fcst COV is the standard deviation of the Cons Fcst Error over COV weeks/Average Fcst over COV weeks, where COV weeks is a variable set i as a part of the global variables as discussed above in reference to FIG. 1. In this case, the number of COV weeks is 8, the standard deviation of 8-week Cons Fcst error is 3807.95, average 8-week RLT Cons fcst is −19,039.75, and thus Cons Fcst COV=3807.95/19,039.75=20%.

Avg FVA is a measure of the relative performance of the forecast versus the consumption based forecast over the FVA weeks, where FVA weeks is a variable set as a part of the global variables as discussed above in reference to FIG. 1. To calculate Avg FVA, the absolute value of the sum of the Fcst Error is subtracted from the absolute value of the sum of the Cons Fcst Error and the resulting quantity is divided by the absolute value of the sum of the RLT Actuals. In this case, the number of FVA weeks is 8, the absolute value of the sum of the Fcst Error is 14809, the absolute value of the sum of the Cons Fcst Error is 152318, and the absolute value of the sum of the RLT Actuals is 252.966. The Avg FVA is (152318−14809)/252,966=54%.

In one implementation, the value of Avg FVA may be disregarded. The forecast value analysis platform may consider the direction (“+” or “−”). In one implementation, the forecast value analysis platform may use the FVA value to generate recommendation. More specifically, “+” indicates that error in consumption is greater than forecast, and thus fcst ROP type is recommended. “−” indicates that error in consumption is less than forecast, and accordingly, cons ROP type is recommended.

In one implementation, the analysis component 400 may comprise a summary data 430. The summary data 430 may be copied from the calculated values as discussed above in reference to FIG. 4.

In one implementation, the analysis component 400 may comprise a skip column. Each row in the skip column may be marked Y (e.g., yes) or may be left blank. In the event that the skip column is left blank, the calculations for all the variables discussed above may be calculated considering all the related data. The data associated with products whose skip column is marked Y is excluded from the calculations.

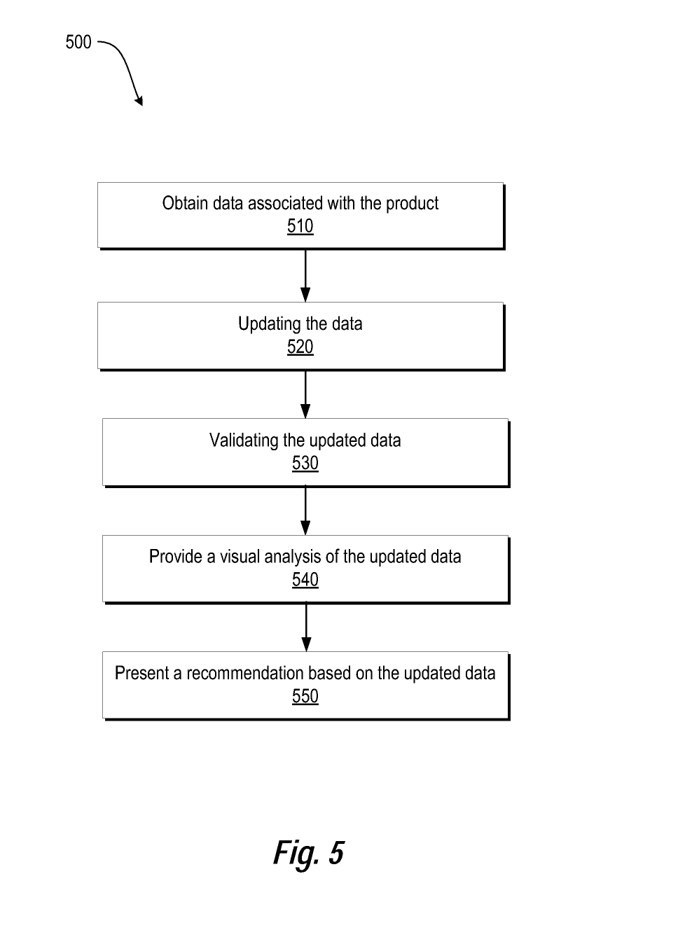

Turning now to the operation of the platform 110 of FIG. 1, FIG. 5 illustrates an example process flow diagram 500 in accordance with an implementation. It should be readily apparent that the processes illustrated in FIG. 5 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with the platform 110. Furthermore, FIG. 5 is not intended to limit the implementation of the described implementations, but rather the figure illustrates functional information one skilled in the art could use to design/fabricate circuits, generate software, or use a combination of hardware and software to perform the illustrated processes. Also, the various operations depicted in FIG. 11 may be performed in the order shown or in a different order and two or more of the operations may be performed in parallel instead of serially.

The process 500 may begin at block 510, where the system obtains data associated with the product. In one implementation, the data comprises forecast value add, replenishment lead time (RLT), ROP type, current, forecast, and historical consumption coefficient of variation data related to the product. In one example, the data may be received from various components of a forecast value analysis platform. In other examples, the data may be pulled from a single database or may be compiled from several databases distributed across an organization and connected via a network, such as a wide area network (WAN), a storage area network (SAN), or in various data servers connected to the internet.

Moreover, this process may also include the user (e.g., the inventory manager) identifying a product. The user may select one or more products. In one implementation, the user may select the products from a drop down menu may be generated based on the user's identification. If the user provides ID information, the system displays the products that are associated with such user as options on the drop down menu.

At block 520, the system proceeds to update the obtained data by adjusting the calculations associated with the parameters defined in the system. This process may include identifying data points that may need to be excluded from the calculations of the parameters. That is, the system may perform the calculations without including such data points. In one implementation, the user may specify the data points to be eliminated. In another implementation, the system may generate a list of data points that act as outliers.

Once the data is updated based on the adjusted calculations, at block 530, the system initiates a process to validate the updated data. More specifically, the system may determine whether the data associated with the product is sufficient. In the event that the data is found to be sufficient, no additional data validation or assignments are necessary. In the event that the system concludes that the data is insufficient, the system may provide the user a plurality of override process options. As discussed above in greater detail in reference to FIG. 3, the types of overrides that may be available to the user may comprise predecessor, product line average (PL-avg) and custom. Depending on the selected method for overriding the existing data to provide additional information about the product, the system populates various fields with data related to the product.

At block 540, the system generates and displays visual analysis of the updated and validated data. As described in greater detail in reference to FIGS. 3-4, this process may include generating various graphical representations and pivot table worksheets based on the data.

At block 550, based on the updated and validated data associated with the product, the system presents a recommendation for the user to consider in order to optimize inventory performance. In one implementation, the system may review the forecast value add value of the product, and based on the review, the system may make a ROP recommendation. In particular, if the FVA is positive, the system recommends selecting the forecast based ROP. If the FVA is negative, the system may check whether the consumer based ROP covers the forecast. In the event that the consumer based ROP does not cover the forecast, the system recommends selecting the forecast based ROP. In the event that the consumer based ROP covers the forecast, the system recommends consumer based ROP. Further, in response to the recommendation, the user may select the ROP type recommended by the system.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

1. A processor-implemented method for analyzing product data, comprising:
obtaining, by at least one processor, data associated with a product, the data comprising a plurality of parameters;
updating, by the at least one processor, the data based on elimination of at least one data point in the data;
validating, by the at least one processor, the updated data;
providing, by the processor, visual analysis of the updated data; and
determining, by the at least one processor, a recommendation based on the updated data, wherein the recommendation is related to at least one of the plurality of parameters.

2. The method of claim 1, wherein updating the data further comprising:
receiving, from a user, a request for the elimination of the at least one data point;
performing the elimination of the at least one data point from the data; and
calculating the plurality of parameters based on the elimination.

3. The method of claim 1, wherein validating the updated data further comprising:
determining sufficiency of the data; and
providing at least one override option to the user if the data is insufficient.

4. The method of claim 3, wherein the at least one override option comprises predecessor, product line average and custom.

5. The method of claim 1, further comprising receiving a selection of the product from a user.

6. The method of claim 1, wherein providing visual analysis of the data further comprising displaying graphics and tables.

7. The method of claim 1, further comprising setting a plurality of global variables, the global variables used for calculating the plurality of parameters.

8. The method of claim 1, wherein the plurality of parameters comprises replenishment lead time (RLT), RLT forecast, RLT consumption forecast and RLT actuals.

9. The method of claim 1, wherein the at least one of the plurality of parameters relates to re-order point (ROP), comprising a forecast based re-order point and a historical consumption based re-order point, and the recommendation is to use forecast ROP if error in consumption is greater than forecast.

10. The method of claim 1, further comprising storing the updated data associated with the product in the database.

11. A system, comprising:
a data capturing module to obtain data associated with a product, the data comprising a plurality of parameters;
a calculation module to update the data by removing at least one data point from the data, and calculate the plurality of parameters using the updated data;
a replacement module to validate the updated data based on sufficiency of the data related to the product;
a display module to provide visual analysis of the updated data, the display module controlling a plurality of display regions representing at least one of the plurality of parameters; and
a recommendation module to provide a recommendation related to at least one of the plurality of parameters.

12. The system of claim 11, further comprising at least one user interface to provide a plurality of user controllable features for selecting the product.

13. The system of claim 11, further comprising a database to store the updated data.

14. A non-transitory computer-readable medium comprising instructions that when executed cause a system to:
obtain data associated with a product, the data comprising a plurality of parameters, the plurality of parameters comprising replenishment lead time (RLT), RLT forecast, RLT consumption forecast, and RLT actuals;
update the plurality of parameters based on an elimination of at least one data point in the data;
validate the plurality of parameters, wherein some of the plurality of parameters relate to a forecast based re-order point (ROP) and a historical consumption based re-order point; and
recommend the forecast based ROP to a user if error in consumption is greater than forecast.

15. The non-transitory computer-readable medium of claim 14, further comprising instructions that when executed cause a system to providing visual analysis of the updated data.

16. The non-transitory computer-readable medium of claim 14, wherein the visual analysis comprises a graphic and a table.

17. The non-transitory computer-readable medium of claim 14, comprising instructions that when executed cause the system to set global variables used for calculating the plurality of parameters.

18. The system of claim 11, wherein the plurality of parameters comprises replenishment lead time (RLT), RLT forecast, RLT consumption forecast, and RLT actuals.

19. The system of claim 11, wherein least some of the plurality of parameters comprise re-order point (ROP) comprising a forecast based re-order point and a historical consumption based re-order point, and wherein the recommendation is to use forecast ROP in response to error in consumption being greater than forecast.

20. The system of claim 11, comprising:
a processor; and
a computer readable medium storing modules executable by the processor, the modules comprising the data capturing module, the calculation module, the replacement module, the display module, and the recommendation module.
